(19) United States
(12) Patent Application Publication
(10) Pub. No.: US 2026/0187158 A1
(43) Pub. Date: Jul. 2, 2026

(54) ELECTRONIC SUBMISSION OF DOCUMENTS TO ENTITIES BASED ON MACHINE LEARNING

(71) Applicant: International Business Machines Corporation, Armonk, NY (US)

(72) Inventors: Sanmitra Sarkar, Kolkata (IN); Mukundan Sundararajan, Bangalore (IN); Jignesh Karia, Thane (IN); Sumitro Ghatak, Kolkata (IN)

(21) Appl. No.: 19/007,730

(22) Filed: Jan. 2, 2025

(51) Int. Cl. G06F 16/93; G06F 16/906

(52) U.S. Cl. CPC G06F 16/93; G06F 16/906; G06F 16/908; G06N 20/00

(57) ABSTRACT

According to an embodiment of the present invention, a computer system comprises a processor set, one or more computer-readable storage media, and program instructions stored on the one or more computer-readable storage media to cause the processor set to perform operations. The system analyzes a document to obtain parameters including an area of research in the document and metrics for quality of the document. A document influence score of the document is determined based on the parameters. An author influence score is determined based on a quantity of citations to an author of the document. An entity is selected for submission of the document based on the document influence score and the author influence score. The document is electronically submitted to the selected entity. Embodiments of the present invention further include a method and computer program product for electronically submitting a document in substantially the same manner described above.

### BACKGROUND

### 1. Technical Field

Present invention embodiments relate to electronic document submission, and more specifically, to identifying appropriate entities for documents and electronically submitting the documents over a network to the identified entities based on machine learning (and without human intervention).

### 2. Discussion of the Related Art

A significant amount of time and effort are utilized to prepare a research paper for submission to a journal or conference proceedings. Several papers may be rejected as being unsuitable for a specific journal or out of scope for a particular journal or conference. Current approaches may employ subject area classification for scientific papers using a Bidirectional Encoder Representations from Transformers (BERT) model, or may use machine learning (ML) techniques to classify different publications into multiple fields. However, these approaches fail to consider criteria of the journal for papers, thereby leading to rejection of the papers.

### SUMMARY

According to an embodiment of the present invention, a computer system comprises a processor set, one or more computer-readable storage media, and program instructions stored on the one or more computer-readable storage media to cause the processor set to perform operations. The system analyzes a document to obtain parameters including an area of research in the document and metrics for quality of the document. A document influence score of the document is determined based on the parameters. An author influence score is determined based on a quantity of citations to an author of the document. An entity is selected for submission of the document based on the document influence score and the author influence score. The document is electronically submitted to the selected entity. Embodiments of the present invention further include a method and computer program product for electronically submitting a document in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a procedural flowchart of a method of electronically submitting a document to an entity according to an embodiment of the present invention.

FIG. 3 is a diagrammatic illustration of an example neural network used by an embodiment of the present invention.

FIG. 4 is a flow diagram of selecting an entity for a document according to an embodiment of the present invention.

FIG. 5 is a flow diagram of a manner of electronically submitting a document to an entity according to an embodiment of the present invention.

### DETAILED DESCRIPTION

An embodiment of the present invention automatically identifies entities (e.g., managing journals, conferences, etc.) and electronically submits papers or other documents (e.g., research papers, scientific papers, medical papers, news articles, topical papers, screenplays, scripts, etc.) over a network to the entities directly without any human intervention. The embodiment of the present invention eases the process of paper submission since the author of a paper does not need to search for a proper journal. Further, the embodiment of the present invention provides editorial boards or other entities of journals or conferences the ability to screen papers to eliminate non-matching and poor-quality papers. Although some human review may be performed, the embodiment of the present invention drastically reduces time, effort, and cost of review for publishing organizations.

An embodiment of the present invention uses a combination of various machine learning (ML) models to generate a document influence score and an author influence score. The document influence score is determined using an ML model and is based on quality and subject area of the document. The author influence score is based on an author's importance or social acceptance. The document and author influence scores determine the suitability of a research paper or other document for a particular journal/conference. In addition, the embodiment of the present invention automatically adapts the document to the referencing style of a selected conference/journal or other entity automatically.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

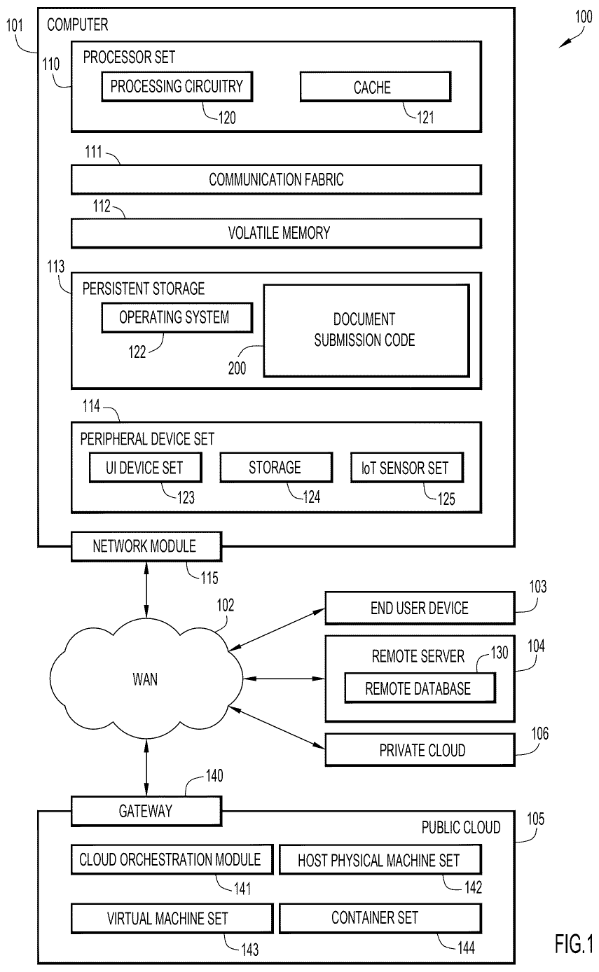

Referring to FIG. 1, computing environment 100 contains an example of an environment for the execution of at least some of the computer code involved in performing the inventive methods, such as document submission code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): public and private clouds 105, 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offerings is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

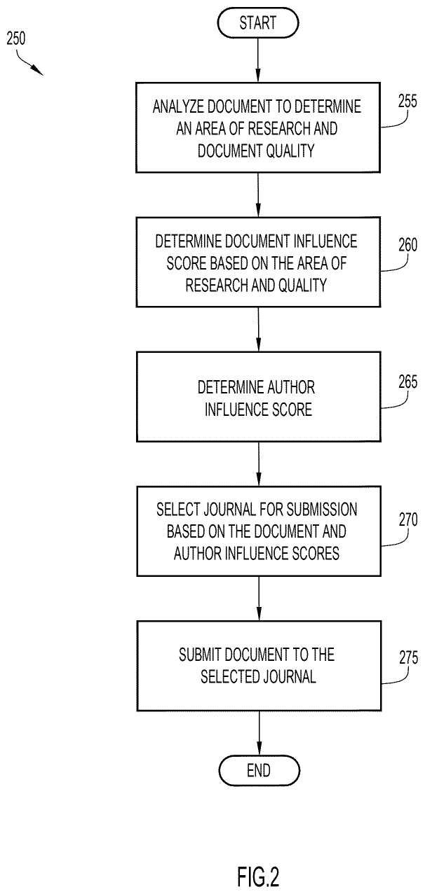

A method 250 of electronically submitting a document (e.g., via document submission code 200, computer 101, etc.) according to an embodiment of the present invention is illustrated in FIG. 2. A document and corresponding information (e.g., research paper, author, etc.) is received (or accessed from storage). The document and information are analyzed to determine an area of research and document quality at operation 305. The subject area of the research paper is initially determined. For example, a list of keywords and phrases within the research paper may be identified to determine the subject of the research paper. The keywords are parsed and n-grams are calculated for words and combinations of words. An n-gram may include any quantity (n) of tokens (e.g., words, characters, etc.). By way of example, bi-grams and tri-grams may be determined and one-hot encoded. Historical data with a target variable of a subject area coding is used to build a classification machine learning model.

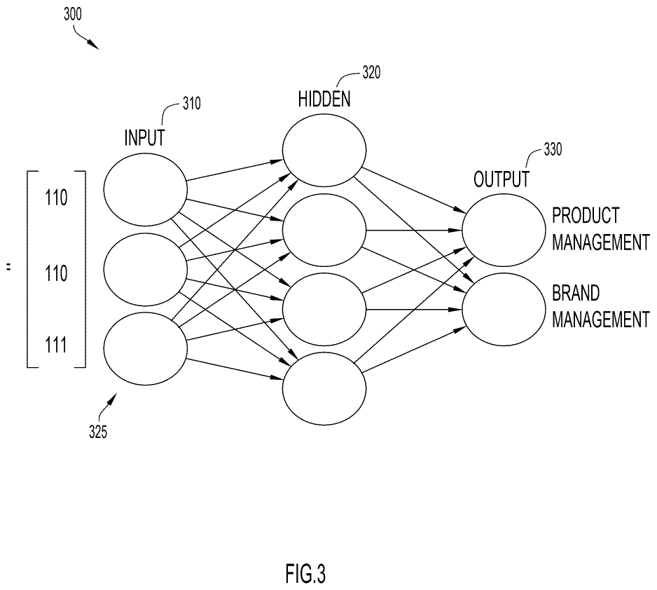

The machine learning model may include any conventional or other machine learning models (e.g., mathematical/statistical, classifiers, feed-forward, recurrent, convolutional, deep learning, or other neural networks, large language models (LLM), etc.). For example, the machine learning model may include one or more neural networks. By way of example and referring to FIG. 3, a neural network 300 may include an input layer 310, one or more intermediate layers (e.g., including any hidden layers) 320, and an output layer 330. Each layer includes one or more neurons 325, where the input layer neurons receive input (e.g., data or features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various example data, features, and/or information as input (e.g., n-grams of keywords addressing a subject area of the paper, encodings of the n-grams, etc.) and corresponding desired outputs or classes (e.g., relevant subject areas, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output or class (e.g., corresponding to a subject area, etc.). The output with the highest probability may be selected as the result.

When a new research paper is received, the keywords are parsed and n-grams are created and encoded using one-hot encoding. The encoded n-grams are processed by the classification machine learning model which classifies the research paper to a specific subject area.

For example, a research paper may include a phrase “Brand equity is high.” The phrase can be partitioned into n-grams ‘Brand’, ‘Brand equity’ and ‘Brand equity high’, and one-hot encoded into a bit or other vector. By way of example, a first (or most significant) position of the vector may correspond to the term ‘Brand’, a second position of the vector may correspond to the term ‘equity’, and a third (or least significant) position of the vector may correspond to the term of ‘high’. A one in a position indicates the corresponding term is present in the n-gram, and a zero in the position indicates the corresponding term is absent from the n-gram. Accordingly, a one-hot encoding of the n-grams may be expressed as bit or other vectors of for ‘Brand’, [110] for ‘Brand equity’, and [111] for ‘Brand equity high’. The encoded n-grams are processed by neural network 300 to be classified into relevant subject areas in substantially the same manner described above (e.g., product management or brand management as viewed in FIG. 3).

Referring back to FIG. 2, once the subject area is identified, a document influence score is determined based on the area of research and quality of the document at operation 260. The quality of the document is measured in plural dimensions. For example, the quality of the document may be based on thoroughness, novelty, academic importance, spread, and/or social significance. Thoroughness may be evaluated by a machine learning model which uses a combination of natural language processing (NLP) and computer vision techniques to produce a thoroughness score, preferably on a scale of one to ten. The machine learning model may include any conventional or other machine learning models (e.g., mathematical/statistical, classifiers, feed-forward, recurrent, convolutional, deep learning, or other neural networks, large language models (LLM), etc.).

Thoroughness may be based on various parameters, such as meticulousness, consistency, and transparency. Meticulousness may be measured based on rigorous research design, research questions, hypotheses, and through active peer review. Consistency may be determined based on logical alignment of a title, purpose, problem, and research question within the document. Consistency begins when a researcher clearly identifies the concepts or constructs of interest and focuses on these constructs when reading literature to help formulate the topic, problem, and purpose of the work. Transparency may be measured through appropriate research questions and comprehensive and up-to-date literature review that summarizes existing knowledge and gaps in the field. Transparency may further be measured based on a study's limitations, assumptions, and uncertainties and their implications for interpreting and generalizing results. Transparency may also be measured based on raw data, code, materials, and protocols used in the study.

The thoroughness parameters may be benchmarked against similar accepted and published papers that are used to train the machine learning model. For example, the machine learning model may include a neural network as described above and trained with a training set including known parameters (and text) of the accepted and published papers as input and the corresponding thoroughness score as output. The received research paper may be processed by the machine learning model to produce the thoroughness score.

Novelty may be determined by a machine learning model where word embeddings are used for main deductions and inference of the document. Basically, each word or phrase may be represented by a vector (or embedding) having numeric elements corresponding to a plurality of dimensions. Words (or phrases with) similar meanings have similar word embeddings or vector representations. The word embeddings are produced from machine learning techniques or models (e.g., neural network, etc.) based on an analysis of word usage in a collection of text or documents. The embeddings or vector representations may be pre-existing, and/or produced using any conventional or other tools or techniques (e.g., GLOVE, WORD2VEC, etc.).

Based on the similarity of the embeddings of a given document to embeddings of documents available online, a similarity score is given to the document. The similarity score may be determined using any similarity or distance metric (e.g., Euclidean distance, cosine similarity, etc.) between embeddings of different documents. Further, a machine learning model may be used to determine the similarity score. The machine learning model may include any conventional or other machine learning models (e.g., mathematical/statistical, classifiers, feed-forward, recurrent, convolutional, deep learning, or other neural networks, large language models (LLM), etc.). For example, a neural network as described above may be trained with a training set including different combinations of documents (or embeddings) as input and known similarity scores as output. The received document is applied to the neural network (that may optionally determine the corresponding embeddings) to produce the similarity score. A lower similarity score indicates greater novelty.

Academic importance may be measured by a machine learning model to predict a number of future citations, where early citation is calculated and the decay of the citation is measured using any conventional or other loss or decay function. The machine learning model may include any conventional or other machine learning models (e.g., mathematical/statistical, classifiers, feed-forward, recurrent, convolutional, deep learning, or other neural networks, large language models (LLM), etc.). For example, a neural network as described above may be trained with a training set including different documents and metrics (e.g., early citation, citation decay, etc.) as input and known future citations as output. The received document and corresponding metrics are applied to the neural network to predict the number of future citations.

Spread represents a number of citations to an author. Spread may be calculated through a machine learning model to predict a citation index (e.g., h-index which may be determined as a maximum value for h, where each of at least h papers have been published by an author or journal and cited at least h times). In other words, the machine learning model predicts the number of publications for which an author would be cited by other authors at least that same number of times as the author's number of publications. The machine learning model may include any conventional or other machine learning models (e.g., mathematical/statistical, classifiers, feed-forward, recurrent, convolutional, deep learning, or other neural networks, large language models (LLM), etc.). For example, a neural network as described above may be trained with a training set including different documents and quantities of citations or citation indexes as input and known quantities of future citations or citation indexes as output. The received document is applied to the neural network to predict the number of future citations or citation index.

The social significance may be determined using any conventional or other keyword based natural language processing (NLP) techniques. For example, social significance or impact may be based on relevance of social factors to a document. The relevance may be based on a frequency of certain keywords (e.g., for social factors) in the document. The frequency of keywords are used to calculate a significance or importance of the words using any conventional or other technique. By way of example, a conventional or other Term Frequency-Inverse Document Frequency (TF-IDF) technique may be employed to indicate the significance of social factors in the document. TF-IDF measures how relevant a word is to a document in a collection of documents. Term frequency (TF) represents a number of times a word appears in a document divided by the total number of words in the document. Inverse document frequency (IDF) represents a logarithm of a quotient of a total number of documents divided by a number of documents in a collection that contain a certain word. TF-IDF is obtained by multiplying the TF and IDF and may be determined relative to collections of documents associated with different social factors. Accordingly, as a term appears in more documents, the TF-IDF metric approaches zero. This metric indicates when a document contributes to and creates an acceptance of the development of various social and economic factors, such as impact to healthcare, impact to government policy making, etc.

A composite score is derived from the various scores described above (e.g., for thoroughness, novelty, academic acceptance, spread, and social significance, etc.). The various scores may be combined in any fashion to produce the composite score (e.g., average, mean, median, weighted combination or average, etc.). The composite score is mapped with journal rankings or journal impact scores (e.g., released by various journal committees, etc.) to produce the document influence score. For example, a composite score of 100 may correspond or be mapped to a certain level (A) or impact factor of the rankings or impact scores to produce the document influence score.

An author influence score for the document is determined at operation 265. The author influence score is based on social acceptance of the author. This may be derived from publicly available professional profiles or other information on social media sites (e.g., citation index, activity and page view scores, etc.).

A journal or other entity is selected for submission of the document (e.g., for publication, etc.) based on the document and author influence scores at operation 270. A suitable journal or other entity is automatically selected that has the highest probability of accepting the document (e.g., for publication, etc.). The probability score is derived using document and author influence scores and the value of a silhouette coefficient.

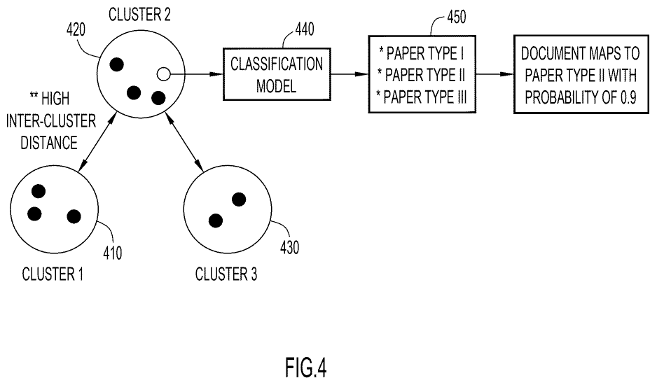

Referring to FIG. 4 by way of example, clustering enables identifying patterns and grouping of similar data points together. The silhouette coefficient is a conventional metric that measures the quality of the clusters. Initially, accepted documents from journals or other entities are clustered via any conventional or other clustering techniques (e.g., k-means clustering, etc.). The clustering may produce cluster 410 (Cluster 1), cluster 420 (Cluster 2), and cluster 430 (Cluster 3) each containing documents accepted by or associated with corresponding journals or other entities and having similar characteristics (e.g., document and author influence scores).

A cluster is selected based on the document influence score and the author influence score of the received document. For example, the silhouette coefficient may be used to determine inter-cluster homogeneity and intra-cluster heterogeneity for a given pair of document and author influence scores. Basically, the silhouette coefficient measures how well a data point fits into its assigned cluster, and combines information about cohesion (how close a data point is to other points in its own cluster) and separation (how far a data point is from points in other clusters). The silhouette coefficient may be determined as the difference between a minimum mean distance between a data point to data points in another cluster and a mean distance between the data point and data points in the same cluster, divided by the greater of the mean (intra-cluster) distance and minimum (inter-cluster) distance. The silhouette coefficient typically has a range from −1 to 1, where a value close to 1 indicates a data point in an appropriate cluster, a value close to 0 suggests overlapping clusters, and a value close to-1 indicates a data point in an inappropriate cluster.

The silhouette coefficient is determined for the document with respect to the document and author influence scores for documents in the respective clusters to determine the appropriate cluster for the document (e.g., a cluster with a silhouette coefficient closest to one with respect to the document may be selected, etc.).

Once the cluster has been determined, the document and author influence scores are processed by a multinomial classification model 440 to identify the journal with the highest probability of acceptance from among a set of journals associated with the documents of the determined cluster.

The multinomial classification model may include any conventional or other machine learning models (e.g., mathematical/statistical, classifiers, feed-forward, recurrent, convolutional, deep learning, or other neural networks, large language models (LLM), etc.). For example, a neural network as described above may be trained with a training set including different documents and metrics (e.g., document and author influence scores, etc.) as input and known type of document as output. The output layer neurons may indicate a probability for the input data being associated with a corresponding output or class (e.g., document type 450, etc.). The received document and influence scores are applied to the neural network to determine a document type and corresponding probability with respect to the documents in the determined cluster. The output with the highest probability may be selected as the result (e.g., paper type II with a probability of 0.9 as viewed in FIG. 4). The journal or entity associated with the determined type of document within the cluster is selected for the document.

Referring back to FIG. 2, the document is electronically submitted (e.g., over a network) to the (e.g., network site of the) selected journal or entity (e.g., for publication, etc.) at operation 275. Once the journal or entity is selected, a specific referencing or citation style of the journal or entity is ascertained from the network site or an accepted document (e.g., APA, Harvard, or any other style of referencing) and automatically implemented using any conventional or other generative or other artificial intelligence (AI)/machine learning model. A final bibliography is automatically changed in the document. The AI or machine learning model may include any conventional or other machine learning models (e.g., mathematical/statistical, classifiers, feed-forward, recurrent, convolutional, deep learning, or other neural networks, large language models (LLM), etc.).

Conventional or other robotic process automation (RPA) processes, including AI bots and/or agents, may be used to complete submission details for the document to the journal or other entity. The RPA processes, bots, and/or agents may employ any conventional or other machine learning models (e.g., mathematical/statistical, classifiers, feed-forward, recurrent, convolutional, deep learning, or other neural networks, large language models (LLM), etc.). The RPA processes identify the form that needs to be completed, and scans the form to determine information requested by the form. An RPA bot enters the information and submits the form.

Once the journal or other entity is selected, an RPA bot actuates a link for the journal or other entity, navigates to a submission section of a corresponding network site, automatically completes the entries required (e.g., author name, a summary of the research paper, major keywords used in the paper, separate images and tables, etc.), and submits the document (and completed form) to the journal, conference, or other entity.

In addition, the journal or other entity may use a present invention embodiment to screen submissions and eliminate non-matching and/or poor-quality papers. For example, the present invention embodiment may process submitted documents in substantially the same manner described above and determine whether a resulting journal or entity matches the entity receiving the submission. When the resulting entity does not match the entity receiving the submission, the corresponding submitted document may be rejected or discarded. There may still be some human review (e.g., for rejected or close cases, etc.), but the present invention embodiment drastically reduces time, effort, and cost of review for the entities.

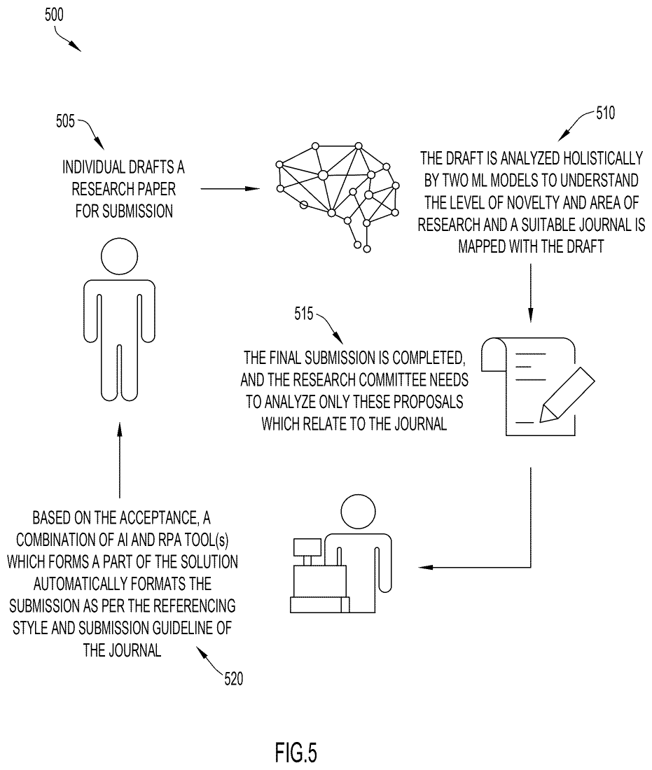

A flow diagram of a method 500 of electronically submitting a document (e.g., via document processing code 200, computer 101, etc.) according to an embodiment of the present invention is illustrated in FIG. 5. By way of example, a user drafts a research paper or other document for submission to a journal or other entity at flow 505. The research paper is analyzed by machine learning models to understand the level of novelty, the area of research, and to determine a suitable journal for submission at flow 510 in substantially the same manner described above. The submission forms are automatically completed at flow 515, and a combination of AI and RPA tools automatically format the submission according to the referencing style and guidelines of the journal at flow 520 in substantially the same manner described above. The research paper is electronically submitted to the journal in substantially the same manner described above. In this case, a research committee needs to analyze only the submitted proposals which relate to the journal.

Present invention embodiments provide various technical and other advantages. For example, an embodiment of the present invention selects appropriate entities based on analysis of documents, thereby reducing processing for incompatible documents. Further, an embodiment of the present invention provides automatic electronic submission of the documents in appropriate formats, thereby reducing processing from erroneous submissions. This also enables identification of appropriate entities across networks and timely submission of documents.

In addition, the machine learning models may be continuously updated (or trained) based on feedback related to acceptance or rejection of documents. For example, a journal or other entity may initially be selected with lower confidence or probability. The journal or entity may be verified based on acceptance of the document. The verified submission may be used to update or train the machine learning model to increase the confidence for the selection (e.g., update or train the machine learning model to increase the probability of the selection, etc.). This updating or retraining of the machine learning model may also be performed for selections with higher confidence or probability that are erroneous based on the verification. Thus, the machine learning model may continuously evolve (or be trained) to learn or improve selections.

It will be appreciated that the embodiments described above and illustrated in the drawings represent only a few of the many ways of implementing embodiments for electronic submission of documents to entities based on machine learning.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., document submission code 200, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems and may store any desired data.

The present invention embodiments may employ any number of any type of user interface (e.g., Graphical User Interface (GUI), command-line, prompt, etc.) for obtaining or providing information (e.g., journals or other entities, acceptance, rejection, referencing style, documents for submission, author information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion and may be configurable based on rules or other criteria to provide desired information to a user (e.g., journals or other entities, acceptance, rejection, referencing style, documents for submission, author information, etc.).

The present invention embodiments are not limited to the specific tasks or algorithms described above but may be utilized for electronic submission and/or formatting of any type of document to any desired entity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
analyzing, via at least one processor, a document to obtain parameters including an area of research in the document and metrics for quality of the document;
determining, via the at least one processor, a document influence score of the document based on the parameters;
determining, via the at least one processor, an author influence score based on a quantity of citations to an author of the document;
selecting, via the at least one processor, an entity from a plurality of entities for submission of the document based on the document influence score and the author influence score, wherein the selecting of the entity comprises:
clustering documents of the plurality of entities into a plurality of clusters, wherein the documents of the plurality of entities exclude the document;
selecting, for the document, a cluster from the plurality of clusters based on a silhouette coefficient of the documents, document influence scores of the documents, and author influence scores of the documents;
determining, within the cluster, a document type corresponding to the document; and
selecting the entity associated with the document type; and
electronically submitting, via the at least one processor and a robotic process automation robot, the document to the selected entity.

2. The computer-implemented method of claim 1, wherein the at least one processor includes one or more machine learning models.

3. The computer-implemented method of claim 1, further comprising:
modifying, via a machine learning model of the at least one processor, the document in accordance with a referencing style of the selected entity.

4. The computer-implemented method of claim 1, wherein the analyzing of the document comprises:
identifying keywords in the document; and
determining, via a machine learning model, the area of research based on encodings of n-grams of the keywords.

5. The computer-implemented method of claim 1, wherein the metrics for quality include thoroughness, novelty, academic importance, spread, and social significance.

6. The computer-implemented method of claim 1, wherein the analyzing of the document to obtain the metrics for quality comprises:
predicting, via a machine learning model, a number of publications for which the author of the document is cited by a set of authors different from the author.

7. (canceled)

8. A computer system, comprising:
a processor set;
one or more computer-readable storage media; and
program instructions stored on the one or more computer-readable storage media to cause the processor set to perform operations comprising:
analyzing a document to obtain parameters including an area of research in the document and metrics for quality of the document;
determining a document influence score of the document based on the parameters;
determining an author influence score based on a quantity of citations to an author of the document;
selecting an entity from a plurality of entities for submission of the document based on the document influence score and the author influence score, wherein the selecting of the entity comprises:
clustering documents of the plurality of entities into a plurality of clusters, wherein the documents of the plurality of entities exclude the document;
selecting, for the document, a cluster from the plurality of clusters based on a silhouette coefficient of the documents, document influence scores of the documents, and author influence scores of the documents;
determining, within the cluster, a document type corresponding to the document; and
selecting the entity associated with the document type; and
electronically submitting, via a robotic process automation robot, the document to the selected entity.

9. The computer system of claim 8, wherein at least one of the operations is performed by one or more machine learning models.

10. The computer system of claim 8, wherein the operations further comprise:
modifying, via a machine learning model, the document in accordance with a referencing style of the selected entity.

11. The computer system of claim 8, wherein the analyzing of the document comprises:
identifying keywords in the document; and
determining, via a machine learning model, the area of research in the document based on encodings of n-grams of the keywords.

12. The computer system of claim 8, wherein
the metrics for quality include thoroughness, novelty, academic importance, spread, and social significance, and
the analyzing of the document to obtain the metrics for quality comprises: predicting, via a machine learning model, a number of publications for which the author of the document is cited by a set of authors different from the author.

13. (canceled)

14. A computer program product, comprising:
one or more computer-readable storage media; and
program instructions stored on the one or more computer-readable storage media to perform operations comprising:
analyzing a document to obtain parameters including an area of research in the document and metrics for quality of the document;
determining a document influence score of the document based on the parameters;
determining an author influence score based on a quantity of citations to an author of the document;
selecting an entity from a plurality of entities for submission of the document based on the document influence score and the author influence score, wherein the selecting of the entity comprises:
clustering documents of the plurality of entities into a plurality of clusters, wherein the documents of the plurality of entities exclude the document;
selecting, for the document, a cluster from the plurality of clusters based on a silhouette coefficient of the documents, document influence scores of the documents, and author influence scores of the documents;
determining, within the cluster, a document type corresponding to the document; and
selecting the entity associated with the document type; and
electronically submitting, via a robotic process automation robot, the document to the selected entity.

15. The computer program product of claim 14, wherein at least one of the operations is performed by one or more machine learning models.

16. The computer program product of claim 14, wherein the operations further comprise:
modifying, via a machine learning model, the document in accordance with a referencing style of the selected entity.

17. The computer program product of claim 14, wherein the analyzing of the document comprises:
identifying keywords in the document; and
determining, via a machine learning model, the area of research in the document based on encodings of n-grams of the keywords.

18. The computer program product of claim 14, wherein the metrics for quality include thoroughness, novelty, academic importance, spread, and social significance.

19. The computer program product of claim 14, wherein the analyzing of the document to obtain the metrics for quality comprises: predicting, via a machine learning model, a number of publications for which the author of the document is cited by a set of authors different from the author.

20. (canceled)
